(19) United States
(12) Patent Application Publication
(10) Pub. No.: US 2026/0204500 A1
(43) Pub. Date: Jul. 16, 2026

(54) SWITCHGEAR

(71) Applicant: Mitsubishi Electric Corporation, Tokyo (JP)

(72) Inventors: Motohiro SATO, Tokyo (JP); Takahiro EDO, Tokyo (JP); Kohei NABEKURA, Tokyo (JP)

(73) Assignee: Mitsubishi Electric Corporation, Tokyo (JP)

(21) Appl. No.: 19/135,382

(22) PCT Filed: Dec. 20, 2022
(86) PCT No.: PCT/JP2022/046932

§ 371 Date: Jun. 4, 2025

(51) Int. Cl. H01H 33/18; H01H 9/44; H01H 33/91

(52) U.S. Cl. CPC H01H 33/182; H01H 9/443; H01H 33/91

(57) ABSTRACT

A switchgear includes: an airtight container; a fixed electrode provided inside the airtight container; and a movable electrode movably provided inside the airtight container. The movable electrode includes: a cylinder having a cylindrical shape; a piston provided in the cylinder; a movable-side contactor having a cylindrical shape having a diameter less than a diameter of the cylinder and fixed to the piston; a support base provided in the movable-side contactor; a permanent magnet fixed to the support base; and a bar formed of a magnetic material, provided adjacent to the support base on a side on which the fixed electrode is disposed. The movable-side contactor has a vent hole formed to penetrate in a radial direction. A puffer chamber, which is a space formed between the cylinder and the movable-side contactor, communicates with a space inside the movable-side contactor through the vent hole.

### FIELD

The present disclosure relates to a switchgear for interrupting an electric current (hereinafter, simply current) in an airtight container enclosing an insulation gas.

### BACKGROUND

Conventionally known devices for interrupting a high-voltage current include a switchgear that interrupts a current in an airtight container enclosing an insulation gas. Such switchgear includes a fixed electrode fixed in the airtight container and a movable electrode movably provided in the airtight container. The switchgear conducts a current in a closed state, in which the movable electrode and the fixed electrode are in contact with each other, and interrupts a current in an open state, in which the movable electrode is separate from the fixed electrode.

During an opening operation, in which a closed state transitions to an open state, an arc occurs between the movable electrode and the fixed electrode. Occurrence of an arc between the movable electrode and the fixed electrode causes a current to flow even though the movable electrode and the fixed electrode are not in contact with each other. This requires the arc occurred between the movable electrode and the fixed electrode to be promptly extinguished during the opening operation.

Patent Literature 1 discloses technology for cooling and extinguishing the arc by rotating the arc through magnetic driving using a magnetic flux generated by a permanent magnet.

### Citation List

### Patent Literature

Patent Literature 1: Japanese Patent Application Laid-open No. 2009-187829

### SUMMARY OF INVENTION

### Problem to Be Solved by the Invention

However, the technology disclosed in Patent Literature 1 described above has current interruption performance that relies only on magnetic driving of the arc, and the structure thereof assumes a low-speed opening operation to exert, on the arc, a magnetic driving force having strength sufficient to cause the arc to rotate.

This results in a low rotational speed of the arc, and thus in poor arc cooling performance when a high-voltage current is to be interrupted, which requires a high-speed opening operation.

In addition, the insulation gas in the airtight container is being changed from SF₆ gas to dry air in these years in consideration of environmental issues. Dry air has, however, arc extinguishing performance poorer than that of SF₆ gas. This additionally requires enhanced arc cooling performance when dry air is used.

The present disclosure has been made in view of the foregoing, and it is an object of the present disclosure to provide a switchgear having enhanced arc cooling performance.

### Means to Solve the Problem

To solve the problem and achieve the object described above, a switchgear according to the present disclosure is a switchgear including: an airtight container enclosing an insulation gas; a fixed electrode provided inside the airtight container; and a movable electrode movably provided inside the airtight container, in which the movable electrode comes into contact with the fixed electrode to make a closed state, and the movable electrode disengages from the fixed electrode to make an open state. The movable electrode includes: a cylinder having a cylindrical shape; a piston provided in the cylinder; a movable-side contactor having a cylindrical shape having a diameter less than a diameter of the cylinder and being fixed to the piston; a support base provided in the movable-side contactor; a permanent magnet fixed to the support base; and a bar formed of a magnetic material and being provided adjacent to the support base on a side on which the fixed electrode is disposed. The movable-side contactor is provided with a vent hole penetrating in a radial direction thereof, and a puffer chamber configured to communicate with a space inside the movable-side contactor through the vent hole is provided, and the puffer chamber is a space formed between the cylinder and the movable-side contactor.

### Effects of the Invention

The present disclosure provides an advantage in providing a switchgear having enhanced and cooling performance.

### BRIEF DESCRIPTION OF DRAWINGS

FIG. 1 is a cross-sectional view of a switchgear according to a first embodiment.

FIG. 2 is a cross-sectional view of the switchgear according to the first embodiment.

FIG. 3 is an enlarged view of a movable portion of a movable electrode of the switchgear according to the first embodiment.

FIG. 4 is a perspective view of a support base of the switchgear according to the first embodiment.

FIG. 5 is a diagram illustrating a magnetic flux generated by a permanent magnet of the movable electrode of the switchgear according to the first embodiment.

FIG. 6 is a diagram illustrating an arc extinction operation during an opening operation of the switchgear according to the first embodiment.

FIG. 7 is a diagram illustrating the arc extinction operation during the opening operation of the switchgear according to the first embodiment.

FIG. 8 is a plan view of the support base of the switchgear according to a second embodiment.

### DESCRIPTION OF EMBODIMENTS

A switchgear according to embodiments will be described in detail below with reference to the drawings.

### First Embodiment

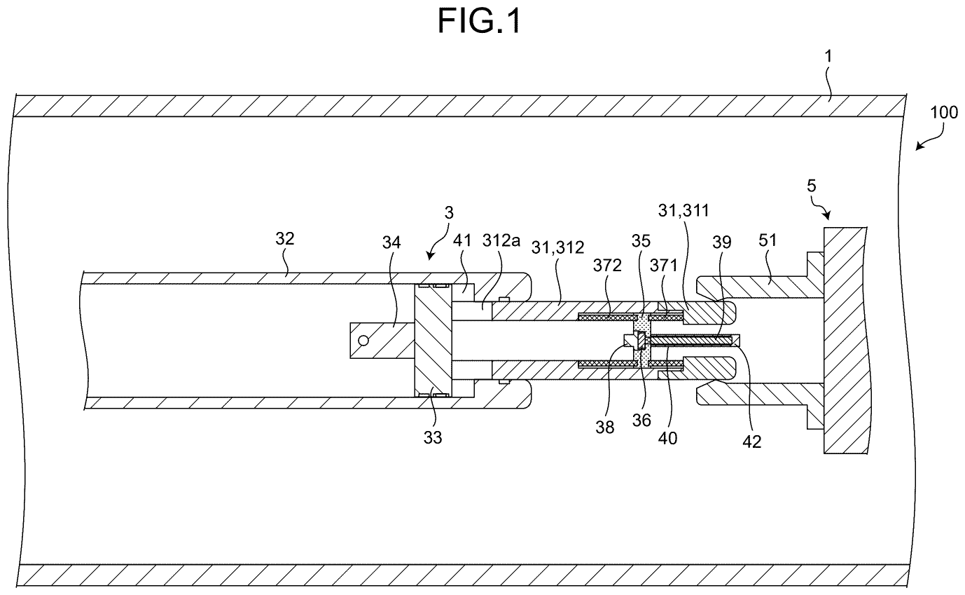

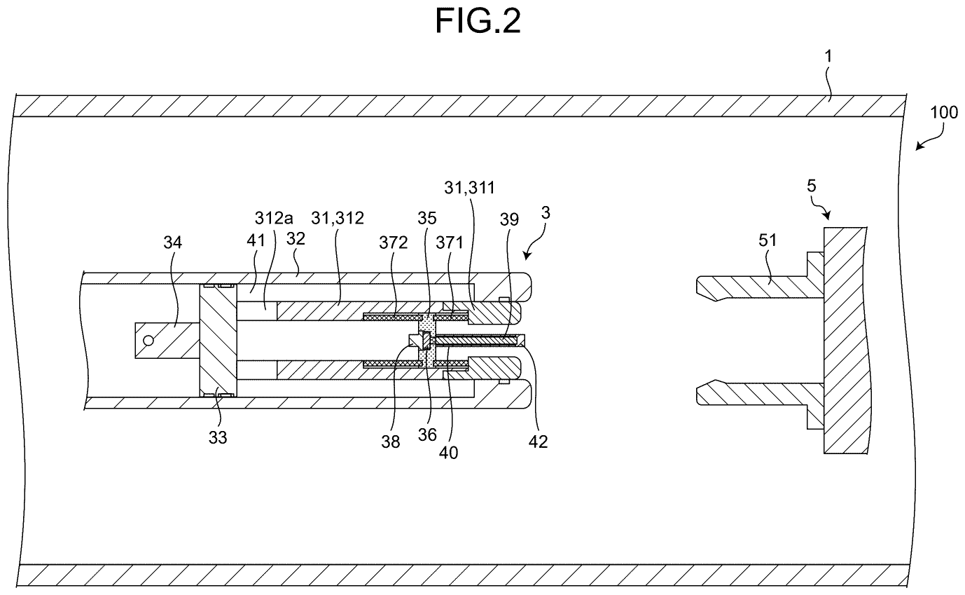

FIGS. 1 and 2 are cross-sectional views of a switchgear according to a first embodiment. A switchgear 100 includes: an airtight container 1 enclosing an insulation gas; a fixed electrode 5 provided inside the airtight container 1; and a movable electrode 3 movably provided inside the airtight container 1. Note that FIG. 1 illustrates a closed state described later, in which the movable electrode 3 and the fixed electrode 5 are in contact with each other; and FIG. 2 illustrates an open state described later, in which the movable electrode 3 and the fixed electrode 5 are separate from each other.

The fixed electrode 5 includes a fixation-side contactor 51 having a cylindrical shape; and the movable electrode 3 includes a movable-side contactor 31 having a cylindrical shape, which is thinner than the fixation-side contactor 51. The movable-side contactor 31 has an outer diameter slightly greater than the inner diameter of the fixation-side contactor 51, thereby causing the movable-side contactor 31 and the fixation-side contactor 51 to be in tight contact with each other in the closed state due to elastic force of each of the movable-side contactor 31 and the fixation-side contactor 51. Note that regarding the alignment direction of the movable-side contactor 31 and the fixation-side contactor 51, a direction from the fixation-side contactor 51 toward the movable-side contactor 31 is herein referred to as “movable side”, while a direction from the movable-side contactor 31 toward the fixation-side contactor 51 is herein referred to as “fixation side”. In addition, a state in which the movable-side contactor 31 and the fixation-side contactor 51 are in contact with each other is herein referred to as “closed state”, while a state in which the movable-side contactor 31 is separate from the fixation-side contactor 51 is herein referred to as “open state”. Note that an example herein is the fixation-side contactor 51 having a cylindrical shape with a diameter greater than the diameter of the movable-side contactor 31, but the fixation-side contactor 51 may have a tulip shape to allow the movable-side contactor 31 to be inserted therein.

As described above, the switchgear 100 becomes a closed state by an action of the movable electrode 3 of coming into contact with the fixed electrode 5, and becomes an open state by an action of the movable electrode 3 of disengaging from the fixed electrode 5.

The movable electrode 3 includes, in addition to the movable-side contactor 31: a cylinder 32 having a cylindrical shape having a diameter greater than the diameter of the movable-side contactor 31; a piston 33 provided inside the cylinder 32; and a rod 34, to which the piston 33 is fixed. The rod 34 is connected to an operation rod of an operation device (not illustrated) to move the piston 33 by driving force transmitted from the operation device (not illustrated). Movement of the piston 33 causes the movable-side contactor 31 to move accordingly inside the cylinder 32.

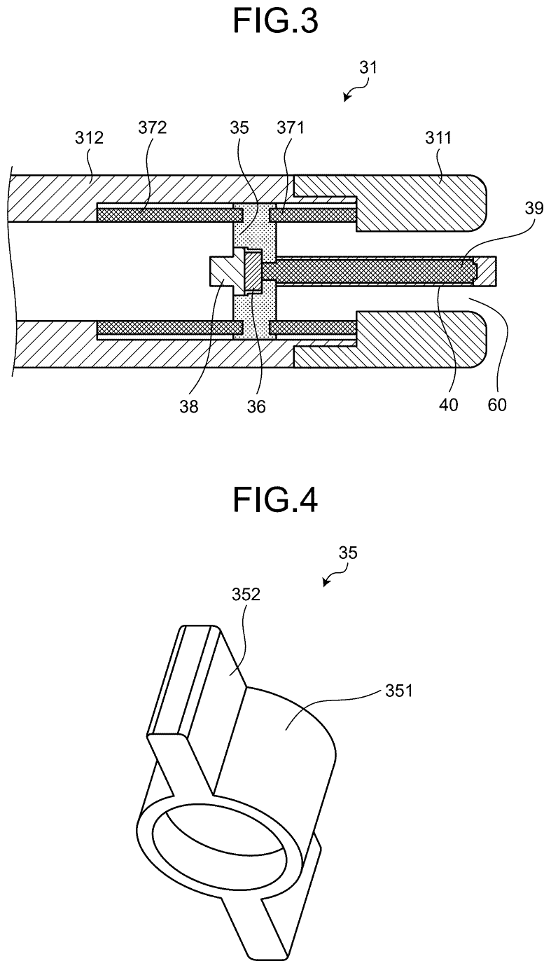

FIG. 3 is an enlarged view of a movable portion of the movable electrode of the switchgear according to the first embodiment. The movable-side contactor 31 includes: a first portion 311, which is to come into contact with, and disengage from, the fixation-side contactor 51; and a second portion 312, which supports the first portion 311. As illustrated in FIGS. 1 and 2, the second portion 312 is fixed to the piston 33. A support base 35, a first tube 371, and a second tube 372 are provided in the movable-side contactor 31. The support base 35 is formed of a nonmagnetic material such as a nonmagnetic metal or an electrically insulating material (hereinafter, simply insulation material). The first tube 371 is formed of a magnetic material, and the second tube 372 is formed of a nonmagnetic material. A permanent magnet 36 is embedded in the support base 35.

FIG. 4 is a perspective view of the support base of the switchgear according to the first embodiment. The support base 35 includes: a magnet holder 351 having a cylindrical shape to embed the permanent magnet 36; and a set of support legs 352 extending in a radially outward direction from the outer circumferential surface of the magnet holder 351.

The magnet holder 351 has, on the fixation side, an opening smaller than the size of the permanent magnet 36, and has, on the movable side, an opening larger than the size of the permanent magnet 36. The permanent magnet 36 is embedded in the magnet holder 351 through the opening on the movable side. The opening of the magnet holder 351 on the movable side is closed by a lid 38, which is formed of a magnetic material, to prevent the permanent magnet 36 from dropping out of the magnet holder 351.

As illustrated in FIG. 3, the support base 35 is fixed in the movable-side contactor 31 in such a manner that the support legs 352 are held between the first tube 371 and the second tube 372. Note that the support base 35 can be prevented from rotating about the axis of the movable-side contactor 31 by forming slits in the first tube 371 and the second tube 372 and placing the support legs 352 in the slits.

A bar 39 is provided adjacent to, and in tight contact with, the permanent magnet 36 on the fixation side. The bar 39 is formed of a magnetic material, and an end portion thereof on the movable side is inserted into the magnet holder 351 to come into contact with the permanent magnet 36. The bar 39 includes an insulation layer 40 over a surface thereof other than the portion that comes into contact with the permanent magnet 36. The insulation layer 40 is formed in such a manner that an electrically insulating tape is wrapped around a magnetic material body serving as a core, or that an insulation material is molded around the magnetic material body. A cap 42 formed of an insulation material is attached on an end portion of the bar 39 on the fixation side. Note that when the insulation layer 40 is formed by molding a magnetic material around the bar 39, the end portion of the bar 39 on the fixation side can also be covered with the insulation layer 40, which enables a structure without the cap 42. The gap between the bar 39 and the movable-side contactor 31 is a nozzle portion 60, through which the insulation gas passes. The end portion of the movable-side contactor 31 on the fixation side is configured to more protrude toward the fixation-side contactor 51 than the end portion of the bar 39 on the fixation side protrudes toward the fixation-side contactor 51; or the end portion of the movable-side contactor 31 on the fixation side and the end portion of the bar 39 on the fixation side are configured to align even with each other.

A vent hole 312a penetrating in the radial direction is formed in the second portion 312 of the movable-side contactor 31. A puffer chamber 41 is formed between the cylinder 32 and the movable-side contactor 31. Volume of the puffer chamber 41 varies in accordance with movement of the piston 33. The volume of the puffer chamber 41 decreases in a closing operation, which causes transition from an open state to a closed state, while the volume of the puffer chamber 41 increases in an opening operation, which causes transition from a closed state to an open state.

When the volume of the puffer chamber 41 increases, gas contained in the airtight container 1 is taken through the opening in the fixation-side end portion of the movable-side contactor 31 to cause a gas flow to occur in the nozzle portion 60, which is the gap between the movable-side contactor 31 and the bar 39.

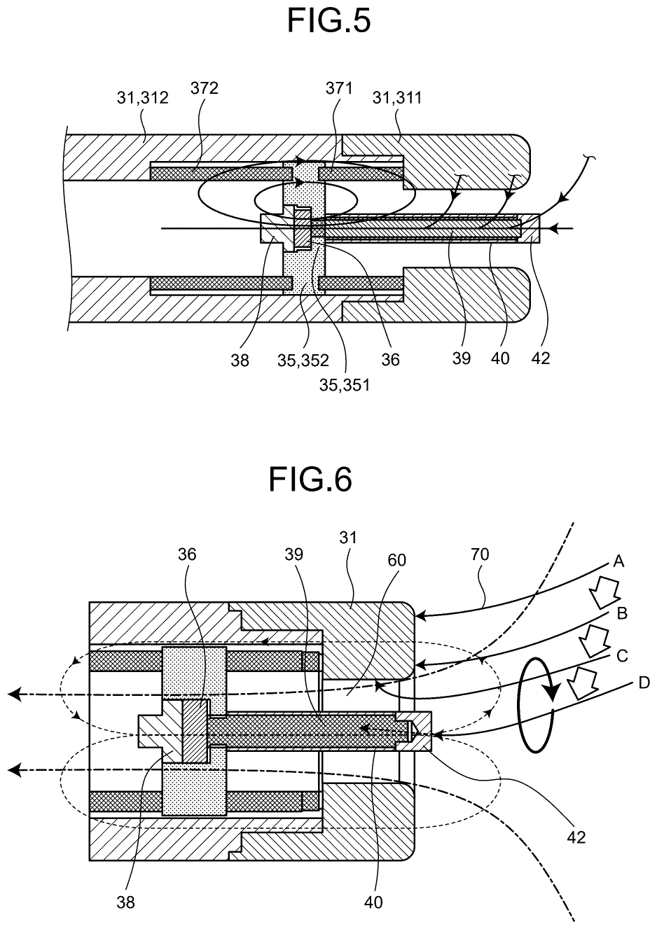

FIG. 5 is a diagram illustrating a magnetic flux generated by the permanent magnet of the movable electrode of the switchgear according to the first embodiment. Due to the configuration in which the bar 39 and the lid 38 are formed of a magnetic material, and the support base 35 is, in contrast, formed of a nonmagnetic material, the magnetic flux generated by the permanent magnet 36 indicated by the arrows in FIG. 5 is readily conductible through the bar 39 and the lid 38, and is non-readily conductible through the support legs 352. In addition, due to the configuration in which the first tube 371 is formed of a magnetic material, and the second tube 372 is, in contrast, formed of a nonmagnetic material, and the bar 39 is longer than the lid 38, the magnetic field generated on the fixation side of the permanent magnet 36 has higher intensity than the intensity of the magnetic field generated on the movable side of the permanent magnet 36. Note that tight contact of the bar 39 with the permanent magnet 36 allows the magnetic flux to be readily conductible through the bar 39, but even when there is a magnetic gap between the bar 39 and the permanent magnet 36, the magnetic field generated on the fixation side of the permanent magnet 36 can be made more intense than the magnetic field generated on the movable side of the permanent magnet 36. Moreover, the first tube 371 may be formed of a nonmagnetic material. Even when the first tube 371 is formed of a nonmagnetic material, the magnetic field generated on the fixation side of the permanent magnet 36 can be made more intense than the magnetic field generated on the movable side of the permanent magnet 36 because the bar 39 is provided adjacent to the permanent magnet 36 on the fixation side.

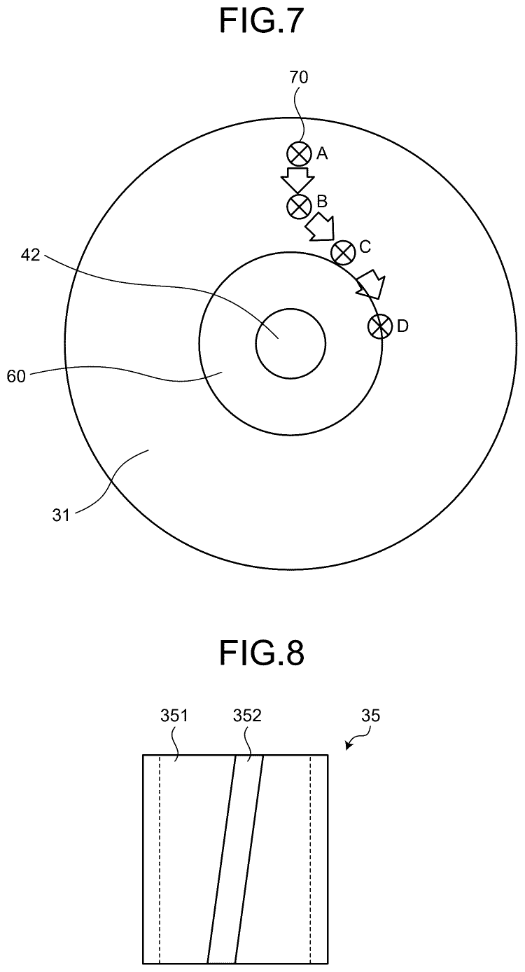

FIGS. 6 and 7 are diagrams illustrating an arc extinction operation during the opening operation of the switchgear according to the first embodiment. FIG. 6 illustrates the arc extinction operation during the opening operation in a cross section of the movable electrode 3. FIG. 7 illustrates the arc extinction operation during the opening operation as viewed from a lateral side of the movable electrode 3 in a direction from the fixation side. FIG. 6 indicates a gas flow generated by increase in the volume of the puffer chamber 41 by dashed-and-dotted line arrows, and the magnetic flux generated by the permanent magnet 36 by broken line arrows When the movable-side contactor 31 disengages from the fixation-side contactor 51 during the opening operation, an arc 70 occurs between the movable-side contactor 31 and the fixation-side contactor 51. In FIGS. 6 and 7, the arc 70 occurs at position A. Note that in FIG. 7, the current of the arc 70 flows along a direction from front to back with respect to the paper plane. The arc 70 occurred between the movable-side contactor 31 and the fixation-side contactor 51 is drawn into the movable-side contactor 31 due to the gas flow generated in the nozzle portion 60 as the volume of the puffer chamber 41 increases. In FIGS. 6 and 7, the arc 70 moves from position A to position B due to the gas flow generated in the nozzle portion 60. When the arc 70 comes near the bar 39, the arc 70 is trapped by the magnetic field of the permanent magnet 36. The magnetic flux flowing out of the permanent magnet 36 through the bar 39 includes a component that crosses the arc 70 generated between the movable-side contactor 31 and the fixation-side contactor 51, thereby causing the arc 70 to rotate in the magnetic field generated by the permanent magnet 36. In FIGS. 6 and 7, the arc 70 trapped by the magnetic field generated by the permanent magnet 36 is drawn with rotation to move from position B to position C, and then from position C to position D. During the opening operation, the arc 70 occurred between the movable-side contactor 31 and the fixation-side contactor 51 is rotatingly drawn into the movable-side contactor 31, and is thus stretched and cooled, and is then extinguished.

Since the insulation layer 40 is formed over the surface of the bar 39, when the arc 70 contacts the insulation layer 40 on the surface of the bar 39, the insulation material included in the insulation layer 40 evaporates and generates an insulating gas due to heat of the arc 70. The insulating gas generated from the insulation layer 40 on the surface of the bar 39 mixes with the arc 70, thereby further cooling the arc 70 and thus making the arc 70 more readily extinguished. When the insulation layer 40 is exhausted by the arc 70, the original condition can be restored by detaching the bar 39 from the support base 35 and rewinding the electrically insulating tape or replacement with another bar 39.

The switchgear 100 according to the first embodiment forcibly generates a gas flow in an opening portion of the movable-side contactor 31 on the fixation side, and also exerts rotational driving force on the arc 70 by the bar 39 formed of a magnetic material and by the permanent magnet 36. This can enhance performance of cooling the arc 70. This enables the switchgear 100 according to the first embodiment to provide interruption performance that satisfies necessary opening and closing requirements even when dry air is used as the insulation gas to be enclosed in the airtight container 1.

### Second Embodiment

The switchgear 100 according to a second embodiment is similar to the switchgear 100 according to the first embodiment except for the support base 35. FIG. 8 is a plan view of the support base of the switchgear according to the second embodiment. The support base 35 of the switchgear 100 according to the second embodiment is configured in such a manner that the support legs 352 extend obliquely with respect to the axial direction of the magnet holder 351. The switchgear 100 according to the second embodiment is used in applications of direct current interruption.

The switchgear 100 according to the second embodiment is configured in such a manner that the support legs 352 of the support base 35 provided in the movable-side contactor 31 extend obliquely with respect to the axial direction of the magnet holder 351. This causes a spiral gas flow to be generated in the movable-side contactor 31 during the opening operation. Matching the rotational direction of the gas flow generated in the movable-side contactor 31 with the direction of rotational driving of the arc 70 caused by the bar 39 and by the permanent magnet 36 will increase the rotational driving of the arc 70 during the opening operation, which can further improve performance of cooling the arc 70.

The configurations described in the foregoing embodiments are merely examples of aspects. These configurations can be combined with another known technology, and part of such configurations can be omitted and/or modified without departing from the spirit.

### Reference Signs List

1 airtight container; 3 movable electrode; 5 fixed electrode; 31 movable-side contactor; 32 cylinder; 33 piston; 34 rod; 35 support base; 36 permanent magnet; 38 lid; 39 bar; 40 insulation layer; 41 puffer chamber; 42 cap; 51 fixation-side contactor; 60 nozzle portion; 70 arc; 100 switchgear; 311 first portion; 312 second portion; 312a vent hole; 351 magnet holder; 352 support leg; 371 first tube; 372 second tube.

1. A switchgear comprising:
an airtight container enclosing an insulation gas;
a fixed electrode provided inside the airtight container; and
a movable electrode movably provided inside the airtight container, in which the movable electrode comes into contact with the fixed electrode to make a closed state, and the movable electrode disengages from the fixed electrode to make an open state, wherein
the movable electrode includes:
a cylinder having a cylindrical shape;
a piston provided in the cylinder;
a movable-side contactor having a cylindrical shape having a diameter less than a diameter of the cylinder and being fixed to the piston;
a support base provided in the movable-side contactor;
a permanent magnet fixed to the support base; and
a bar formed of a magnetic material and being provided adjacent to the support base on a side on which the fixed electrode is disposed, wherein
the movable-side contactor is provided with a vent hole penetrating in a radial direction thereof, and
a puffer chamber configured to communicate with a space inside the movable-side contactor through the vent hole is provided, and the puffer chamber is a space formed between the cylinder and the movable-side contactor.

2. The switchgear according to claim 1, wherein
the bar is in tight contact with the permanent magnet.

3. The switchgear according to claim 1, wherein
the support base is formed of a nonmagnetic material.

4. The switchgear according to claim 1, wherein
the end portion of the movable-side contactor on the fixation side is configured to more protrude toward the fixation-side contactor than the end portion of the bar on the fixation side protrudes toward the fixation-side contactor; or
the end portion of the movable-side contactor on the fixation side and the end portion of the bar on the fixation side are configured to align even with each other.

5. The switchgear according to claim 1, wherein an insulation layer is provided over a surface of the bar.

6. The switchgear according to claim 1, wherein
the support base includes:
a magnet holder having a cylindrical shape configured to embed the permanent magnet; and
a support leg extending in a radially outward direction from an outer circumferential surface of the magnet holder, and
the support leg is configured to extend obliquely with respect to an axial direction of the magnet holder.
